(19) United States
(12) Patent Application Publication
(10) Pub. No.: US 2005/0237052 A1
(43) Pub. Date: Oct. 27, 2005

(54) Acquiring values of back electromotive force for an electric motor

(75) Inventor: Chi Ho Chan, Campbell, CA (US)

Correspondence Address: Michael B. Einschlag;Rosenlaw & Einschlag, 25680 Fernhill Drive, Los Altos Hills, CA, 94024, US

(73) Assignee: Riospring, Inc., Milpitas, CA (US)

(21) Appl. No.: 11/110,657

(22) Filed: Apr. 20, 2005

Related U.S. Application Data
(60) Provisional application No. 60/564,353, filed on Apr. 21, 2004.

(51) Int. Cl. G01B 7/14

(52) U.S. Cl. 324/207.11

(57) ABSTRACT

One embodiment of the present invention is a method for acquiring a value of back electromotive force of an electric motor which includes: (a) applying a first current as input to the electric motor and measuring a first voltage across the electric motor; (b) applying a second current as input to the electric motor and measuring a second voltage across the electric motor; (c) determining a resistance of the electric motor using the first and second voltages and the first and second currents; (d) applying a third current to the electric motor and measuring a third voltage across the electric motor; and (e) determining a value of the back electromotive force using: (i) the third current, the third voltage, the first current, the first voltage, and the resistance; or (ii) the third current, the third voltage, the second current, the second voltage, and the resistance.

This application claims the benefit of U.S. Provisional Application No. 60/564,353 which was filed on Apr. 21, 2004 and which is incorporated herein by reference.

### TECHNICAL FIELD OF THE INVENTION

One or more embodiments of the present invention relate to control of an electric motor, and more particularly, to acquiring values of back electromotive force (BEMF) for use in controlling an electric motor.

### BACKGROUND OF THE INVENTION

In applications using an electric motor, a spindle angular velocity of the motor often needs to be controlled. Considering a head stack assembly (HSA) of a disk drive as an example of such an application, the spindle angular velocity is important because it translates into a loading velocity of a read/write head of the disk drive. Control of the loading velocity is an important factor relating to durability and efficiency of the disk drive. For example, if the loading velocity is too high, the read/write head might crash onto a disk of the disk drive—thereby potentially causing damage to the read/write head and/or the disk. On the other hand, if the loading velocity is too low, a ready-to-read/write time of the read/write head would be too long to enable efficient operation of the disk drive.

As well known in the art, according to Lenz's law, given a constant rotor magnetic field and a constant number of turns in stator windings of an electric motor, back electromotive force (BEMF), i.e., a voltage produced across the stator windings, is proportional to the spindle angular velocity. For this reason, the spindle angular velocity is generally monitored, and attempts to control the spindle angular velocity are typically based on BEMF.

In a disk drive, a voice coil motor (VCM) drives the read/write head. Thus, values of BEMF from the VCM are used to monitor loading velocity of the read/write head since, in accordance with Lenz's law, loading velocity (V)=BEMF*L*K; where L equals a length of an arm that carries the read/write head and K is a constant. However, BEMF cannot be measured directly, and it is conventionally estimated using a value of voltage across the VCM (Vvcm). Vvcm equals a sum of BEMF and a voltage due to VCM resistance which equals VCM current (I)*VCM resistance (R). In practice, the voltage due to VCM resistance is not negligible in magnitude relative to BEMF, and therefore ignoring it can cause significant error in controlling loading velocity. Furthermore, during operation of the disk drive, temperature will increase, and hence, VCM resistance will increase. As a result, the voltage due to the VCM resistance will increase, thereby further increasing error in controlling loading velocity.

In light of the above, there is a need in the art for a method or apparatus for acquiring values of BEMF that solves one or more of the above-identified problems.

### SUMMARY OF THE INVENTION

One or more embodiments of the present invention solve one or more of the above-identified problems. In particular, one embodiment of the present invention is a method for acquiring a value of back electromotive force of an electric motor which comprises: (a) applying a first current as input to the electric motor and measuring a first voltage across the electric motor; (b) applying a second current as input to the electric motor and measuring a second voltage across the electric motor; (c) determining a resistance of the electric motor using the first and second voltage and the first and second currents; (d) applying a third current to the electric motor and measuring a third voltage across the electric motor; and (e) determining a value of the back electromotive force using: (i) the third current, the third voltage, the first current, the first voltage, and the resistance; or (ii) the third current, the third voltage, the second current, the second voltage, and the resistance.

### BRIEF DESCRIPTION OF THE DRAWING

FIG. 1 shows an apparatus that is fabricated in accordance with one or more embodiments of the present invention for use in acquiring values of back electromotive force (BEMF) of an electric motor such as, for example and without limitation, a voice coil motor (VCM) of a disk drive;

FIG. 2 is a flowchart of a method that is fabricated in accordance with one or more embodiments of the present invention (which, for example and without limitation, utilizes the apparatus shown in FIG. 1) for acquiring values of BEMF of an electric motor; and

FIG. 3A shows loading velocity errors of a VCM as a result of estimating values of BEMF of the VCM using voltage differences across the VCM, and FIG. 3B shows loading velocity errors of the VCM using values of BEMF acquired using the method illustrated in FIG. 2.

### DETAILED DESCRIPTION

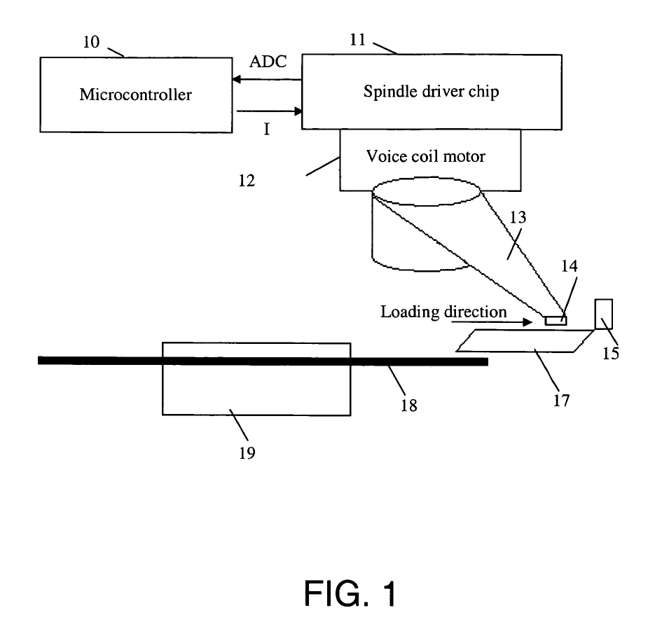

FIG. 1 shows an apparatus that is fabricated in accordance with one or more embodiments of the present invention for use in acquiring values of back electromotive force (BEMF) of an electric motor such as, for example and without limitation, a voice coil motor (VCM) of a disk drive. As shown in FIG. 1, the disk drive includes VCM 12, actuator arm 13, read/write head 14, crash stop 15, ramp 17, disk 18, and disk spindle 19. As is well known to those of ordinary skill in the art, ramp 17 provides a surface that guides read/write head 14 in loading onto and unloading from disk 18, and disk spindle 19 transmits torque from a spindle motor (not shown) to rotate disk 18.

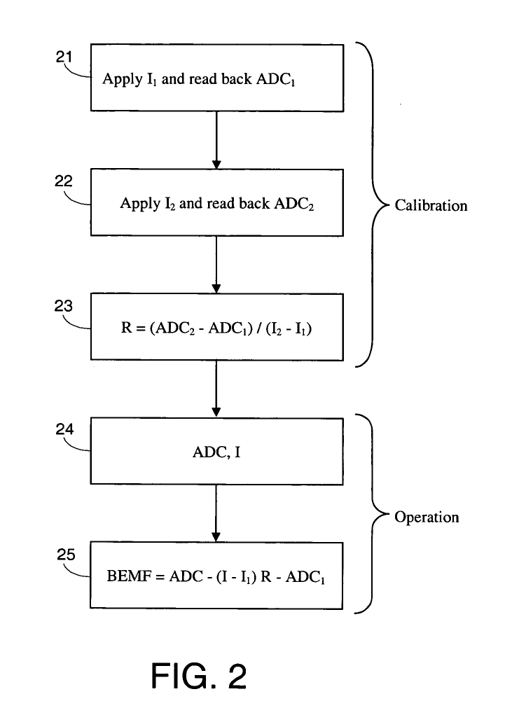

FIG. 2 is a flowchart of a method that is fabricated in accordance with one or more embodiments of the present invention (which, for example and without limitation, utilizes the apparatus shown in FIG. 1) for acquiring values of BEMF of an electric motor. The method starts with step 21 (shown in FIG. 2) at which microcontroller 10 (shown in FIG. 1) commands spindle driver chip 11 to apply current I₁ as input to VCM 12. In this context the term applying current as input to VCM 12 means applying current as input to the voice coil of VCM 12, and more generally, the term applying current as input to an electric motor means applying current as input to a coil of the electric motor.

In accordance with one or more embodiments of the present invention, current I₁ is designed so that it causes VCM 12 to drive actuator 13 in a direction wherein read/write head 14 is pinned against crash stop 15. Once read/write head 14 is pinned against crash stop 15, VCM 12 does not more. At that time, in accordance with Lenz's law, the value of BEMF of VCM 12 is 0. Thus, the voltage across VCM 12 only includes a contribution from a product of VCM 12 resistance (R) and I₁, denoted as I₁R. In this context the term voltage across VCM 12 means a voltage across the voice coil of VCM 12, and more generally, the term voltage across an electric motor means a voltage across the coil of the electric motor. In this context the term VCM 12 resistance (V) means a resistance of the voice coil of VCM 12, and more generally, the term resistance of an electric motor means a resistance of the coil of the electric motor.

In accordance with one or more embodiments of the present invention, microcontroller 10 is a commercially available microcontroller such as, for example and without limitation, an ST AIC-5465 microcontroller that is available from STMicroelectronics, Inc. (www.st.com) of Carrollton, Tex. Further, in accordance with one or more embodiments of the present invention, spindle driver chip 11 is an integrated circuit chip (that is equipped: (a) to supply current; and (b) to provide an analog-to-digital conversion of a voltage) such as, for example and without limitation, a Marvell 88M1500 v1.5 chip that is commercially available from Marvell Semiconductor, Inc. (www.marvell.com) of Sunnyvale, Calif. Spindle driver chip 11 outputs a measured voltage ADC₁ which is recorded by microcontroller 10.
ADC₁=I₁R+Offset (1)

where Offset is a standard value inherent in any analog-to-digital conversion value output from spindle driver chip 11. Then, control is transferred to step 22 (shown in FIG. 2).

At step 22 (shown in FIG. 2), microcontroller 10 (shown in FIG. 1) commands spindle driver chip 11 to apply current I₂ as input to VCM 12 wherein I₂ is different from I₁. In accordance with one or more embodiments of the present invention, current I₂ is designed so that it causes VCM 12 to drive actuator 13 in a direction wherein read/write head 14 is pinned against crash stop 15. Again, since VCM 12 is 0. Thus, the voltage across VCM 12 only includes a contribution from a product of VCM 12 resistance (R) and I₂, denoted as I₂R. Accordingly, spindle driver chip 11 outputs a measured second voltage ADC₂ which is recorded by microcontroller 10.
ADC₂=I₂R+Offset (2)

Then, control is transferred to step 23 (shown in FIG. 2).

At step 23 (shown in FIG. 2), microcontroller 10 calculates VCM 12 resistance (R) as follows:
R=(ADC₂−ADC₁)/(I₂−I₁) (3)

As one can readily appreciate from the above, steps 21-23 provide a calibration process wherein the value of VCM 12 resistance (R) is determined. Then, control is transferred to operative steps 24 and 25 (shown in FIG. 2).

At step 24 (shown in FIG. 2), microcontroller 10 (shown in FIG. 1) commands spindle driver chip 11 to apply an operating current I as input to VCM 12. In response, spindle driver chip 11 outputs a measured voltage ADC which is recorded by microcontroller 10. Then, control is transferred to step 25 (shown in FIG. 2).

At step 25 (shown in FIG. 2), microcontroller 10 (shown in FIG. 1) calculates a value of BEMF that corresponds to operating current I utilizing values of ADC, I, ADC₁, I₁, and R as follows (note that: (a) ADC=BEMF+IR+Offset; and (b) from eqn. (1), Offset equals ADC₁−I₁R or ADC₂−I₂R).
BEMF=ADC−IR−(ADC₁−I₁R)=ADC−(I−I₁)R−ADC₁ (4)
BEMF=ADC−IR−(ADC₂−I₂R)=ADC−(I−I₂)R−ADC₂ (5)

Advantageously, in accordance with one or more embodiments of the invention, the value of BEMF has been determined while accounting for VCM 12 resistance (R).

In accordance with one or more embodiments of the present invention, the calibration process (i.e., steps 21, 22, and 23) is always carried out immediately before the operating process (i.e., steps 24 and 25) is carried out. As a result, the value of VCM 12 resistance (R), and therefore the effect of temperature on the accuracy of measurement of values of BEMF, is calibrated in near real time.

In accordance with one or more embodiments of the present invention, loading velocity of read/write head 14 may be controlled as follows. First, a target value of BEMF that corresponds to a target loading velocity of read/write head 14 is determined. This may be done using the well known relation (described in the Background of the Invention), loading velocity (V)=BEMF*L*K; where L equals a length of an arm that carries the read/write head and K is a constant. Next, using the value of target BEMF, an initial operating current is determined. For example, one may choose a value of initial operating current that moves read/write head 14 off ramp 17, which value may be determined routinely without undue experimentation. All of these steps may be carried out using microcontroller 10.

Next, the calibration process (i.e., steps 21-23 of FIG. 2) is carried out using microcontroller 10 and spindle driver chip 11 in the manner described above. Next, the operating process (i.e., steps 24-25 of FIG. 2) is carried out using microcontroller 10 and spindle driver chip 11 with the initial operating current in the manner described above. Next, microcontroller 10 compares the measured value of BEMF with the target value. In accordance with one or more embodiments of the present invention, if the measured value is greater than the target value by a first predetermined amount, microcontroller 10 reduces the operating current by a second predetermined amount. If the measured value is less than the target value by a third predetermined amount, microcontroller 10 increases the operating current by a fourth predetermined amount. Lastly, if the measured value and the target value differ by less than a fifth predetermined amount, microcontroller 10 makes no change to the operating current. Next, the operating process is carried out again using microcontroller 10 and spindle driver chip 11 with the new operating current in the manner described above. Then, the comparison step is again carried out. As one or ordinarily skill in the art can readily appreciate, the operating process and the comparison steps may be carried out iteratively for as long as it is desired to control the loading velocity. In addition, and as those or ordinary skill in the art can readily appreciate, the predetermined amounts can have values appropriate to a particular disk drive design, which values may be determine routinely and without undue experimentation.

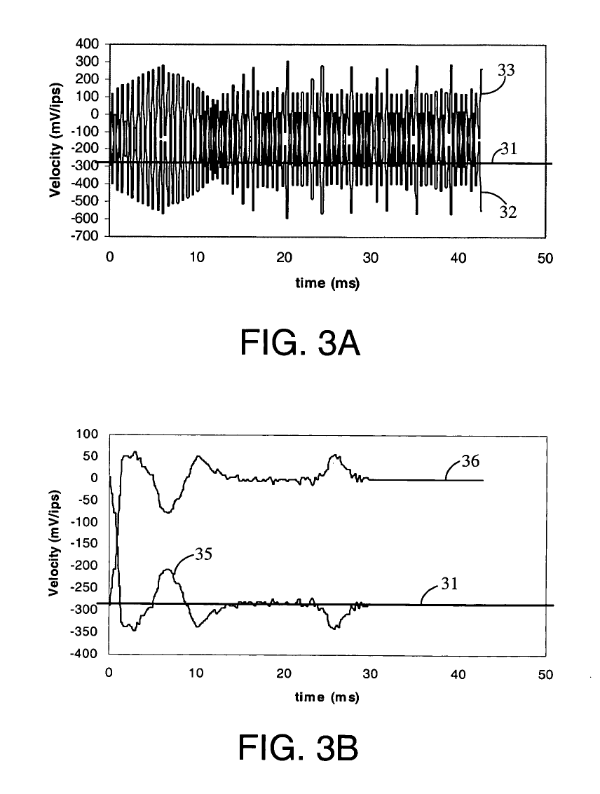

FIG. 3A shows VCM velocity error 33 of VCM 12 as a result of estimating values of BEMF of VCM 12 using voltage differences across VCM 12 in accordance with a conventional method. FIG. 3B shows VCM velocity error 36 of VCM 12 using values of BEMF determined in accordance with the method shown in FIG. 2. As shown in FIGS. 3A and 3B, target VCM velocity 31 is −280 mV/ips (in units of millivolts divided by inches per second), and VCM 12 runs for about 43 milliseconds. A velocity error is defined as a target velocity minus a measured velocity.

As shown in FIG. 3A, in accordance with the conventional method, VCM velocity 32 oscillates between about 300 mV/ips and about −600 mV/ips, and VCM velocity error 33 oscillates between about −580 mV/ips to about 320 mV/ips. On the other hand, as shown in FIG. 3B, in accordance with one or more embodiments of the present invention, improved VCM velocity 35: (a) first goes from 0 mV/ips to about −350 mV/ips; (b) varies between about −350 mV/ips and about −200 mV/ips; and (c) stabilizes at −280 mV/ips (i.e., target VCM velocity 31) in about 31 milliseconds. Further, as shown in FIG. 3B, reduced VCM velocity error 36: (a) first varies between and 70 mV/ips and about 80 mV/ips; and (b) then stabilizes at 0 mV/ips in about 31 milliseconds.

Advantageously in accordance with one or more embodiments of the present invention, the effect of internal resistance of a motor in measuring BEMF values is eliminated. As a result, the accuracy of motor angular velocity control may be improved. As an example, a disk drive with VCM velocity (and therefore read/write head loading velocity) control based on values of BEMF that are acquired through an apparatus or method fabricated in accordance with one or more embodiments of the present invention may have improved velocity control, which results in safer and faster read/write head loading, and therefore higher reliability and efficiency than conventional disk drives.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents. For example, although FIG. 1 shows an apparatus that includes microcontroller 10 and spindle driver chip 11, further embodiments of the present invention may exist wherein these two components may be fabricated as a single controller chip.

1. A method for acquiring a value of back electromotive force of an electric motor which comprises:
applying a first current as input to the electric motor and measuring a first voltage across the electric motor;
applying a second current as input to the electric motor and measuring a second voltage across the electric motor;
determining a resistance of the electric motor using the first and second voltages and the first and second currents;
applying a third current to the electric motor and measuring a third voltage across the electric motor; and
determining a value of the back electromotive force using: (a) the third current, the third voltage, the first current, the first voltage, and the resistance; or (b) the third current, the third voltage, the second current, the second voltage, and the resistance.

2. The method of claim 1 wherein the step of applying the first current causes the motor to stop moving.

3. The method of claim 2 wherein the step of applying the second current causes the motor to stop moving.

4. The method of claim 3 wherein the step of determining the resistance comprises dividing a difference between the first and second voltages by a difference between the first and second currents.

5. The method of claim 4 wherein the step of determining a value of the back electromotive force comprises subtracting the following from the third voltage; (a) the first voltage, and (b) a product of the resistance and a difference between the third current and the first current.

6. The method of claim 4 wherein the step of determining a value of the back electromotive force comprises subtracting the following from the third voltage: (a) the second voltage, and (b) a product of the resistance and a difference between the third current and the second current.

7. An apparatus for acquiring a value of back electromotive force of an electric motor which comprises:
a controller adapted (a) to apply a current as an input to the electric motor, and (b) to measure a voltage across the electric motor; and (c) to execute an algorithm wherein:
the controller applies a first current as input to the electric motor and measures a first voltage across the electric motor;
the controller applies a second current as input to the electric motor and measures a second voltage across the electric motor;
the controller determines a resistance of the electric motor using the first and second voltages and the first and second currents;
the controller applies a third current to the electric motor and measures a third voltage across the electric motor; and
the controller determines a value of the back electromotive force using: (a) the third current, the third voltage, the first current, the first voltage, and the resistance; or (b) the third current, the third voltage, the second current, the second voltage, and the resistance.

8. The apparatus of claim 7 wherein the controller comprises a microcontroller integrated circuit.
